(19) United States
(12) Patent Application Publication
(10) Pub. No.: US 2023/0147900 A1
(43) Pub. Date: May 11, 2023

(54) VEHICLE SIDE REAR VIEW MIRROR HAVING MEANS TO DISPLAY INFORMATION TO COMMUNICATE WITH OTHER INDIVIDUALS OUTSIDE OF THE VEHICLE

(71) Applicant: Orley Hinds, Jamaica, NY (US)

(72) Inventor: Orley Hinds, Jamaica, NY (US)

(21) Appl. No.: 17/520,663

(22) Filed: Nov. 6, 2021

(51) Int. Cl. B60R 1/12; B60Q 1/50; B60Q 1/34; B60Q 1/52; B60R 16/037; B60R 1/06; G09G 3/32

(52) U.S. Cl. CPC B60R 1/1207; B60Q 1/50; B60Q 1/34; B60Q 1/52; B60R 16/0373; B60R 1/06; G09G 3/32; B60Q 2900/30; G06F 3/017

(57) ABSTRACT

A vehicle side rear view mirror having means to display information is used to communicate with other individuals outside of the vehicle. The side rear view mirror assembly includes a base to connect it to the vehicle, a mirror case fixed to the base, at least one light source to display forward through a lens an emoticon or other symbol, and at least one controller to turn the assembly on. The assembly may also include a voice recording or other sound to communicate with other individuals outside of the vehicle. The controller, which is located remotely, could be pushed once or twice to turn on the light source. The light source could be used as a marker light. Alternatively, the controller could be an electrical interrupter controller which would cause the light source to flash so that the light source could be used as a turn signal or hazard lamp. Alternatively, the controller could be voice controlled. Alternatively, the controller could be gesture controlled.

The side rear view mirror assembly may include a matrix of light emitting diodes, which could be color light emitting diodes, to display forward an emoticon or other symbol, a controller, and at least one controller to turn the assembly on and select what emoticon is shown. This assembly may also include a voice recording or other sound to communicate with other individuals outside of the vehicle, or as a turn signal, a hazard light, or a marker light. The controller, which is located remotely, could be pushed once or twice to turn on the light emitting diode array. Alternatively, the controller could be voice controlled. Alternatively, the controller could be gesture controlled.

### TECHNICAL FIELD

The present invention relates generally to the field of motor vehicle side rear view mirrors and more particularly to using motor vehicle side rear view mirrors to communicate an emoticon or other symbol with individuals outside of the vehicle.

### BACKGROUND

The following is a tabulation of some prior art that presently appears relevant:

U.S. Patents

| Patent Number | Kind Code | Issue Date | Patentee |
|---|---|---|---|
| 9,308,867 | B1 | 2016 Apr. 12 | Henion et al |
| 10,661,705 | B2 | 220-05-26 | Juris et al. |

U.S. Patent Application Publications

| Publication Nr. | Kind Code | Publ. Date | Applicant |
|---|---|---|---|
| 2004/0267419 | A1 | 2004 Dec. 30 | Jeng |
| 2005/0117364 | A1 | 2005 Jun. 2 | Rennick |
| 2017/0341569 | A1 | 2017 Nov. 30 | Thompson et al |

Drivers of all types of vehicles commonly desire to communicate with observers such as other drivers and pedestrians. Certain brands of vehicles, such as Jeep, encourage this communication, where it is even known as the “Jeep wave.” Presently this communication is achieved by waving, flicking the high beams, or honking, all of which may be misunderstood by the observer. Waving is limited to daytime hours. This apparatus overcomes these problems by showing an easily understood emoticon or other symbol and optional auditory sound to express the greetings of the driver.

Side rear view mirrors are equipped with indicators, as in U.S. Pat. No. 9,308,867 to Henion et al. The blind spot monitor proposed signals to the driver about the presence of other drivers, the signal is not communicated to other drivers and pedestrians. Furthermore, the signal is automatically generated by the blind spot monitor, it is not controlled by the driver. The signal does not include an audio component.

Side rear view mirrors that are used to communicate turn signals to other drivers are well known. U.S. Pat. No. 10,661,705 to Juris et al. proposes a signal to indicate turns by illuminating a vehicle logo, not signaling an emoticon which signals a greeting to other drivers and pedestrians. Furthermore, there is no audio component.

Side rear view mirrors are known to be used to communicate vehicle safety information to others in U.S. Patent Application Publication number 2004/0267419 to Jeng. In this publication, the side rear view mirror communicates only with computers and other peripherals, not with other individuals such as drivers and pedestrians.

Side rear view mirrors are known to be used to communicate with others outside the vehicle in U.S. Patent Application Publication number 2005/0117364 to Rennick, and U.S. Patent Application Publication number 2017/0341569 to Thompson et al. These publications project the communication on the roadway instead of using the side rear view mirror itself to communicate.

### SUMMARY OF THE EMBODIMENTS

A first embodiment of a vehicle side rear view mirror having means to display information to communicate with other individuals outside of the vehicle includes a base, a light source, a lens, and a remote controller such as a switch. The lens may be shaped as an emoticon or other symbol. The lens may be included in the base. The controller may be an electrical interrupter switch to cause the lights to flash, so that the lights may be used as turn signals, hazard lights, or marker lights.

A second embodiment of a vehicle side rear view mirror having means to display information to communicate with other individuals outside of the vehicle includes a base, an array of light emitting diodes, a controller for the light emitting diodes, and at least one remote controller. The light emitting diodes may be color changing. The light emitting diodes may emit a light which appears as an emoticon.

A third embodiment of a vehicle side rear view mirror having means to display information to communicate with other individuals outside of the vehicle includes a base, a light source, a lens, and a remote controller. The lens may be shaped as an emoticon or other symbol. The lens may be included in the base. The controller may be connected to a voice recorder which sends its output to a speaker located in the side rear view mirror or elsewhere on the motor vehicle.

A fourth embodiment of a vehicle side rear view mirror having means to display information to communicate with other individuals outside of the vehicle includes a base, an array of light emitting diodes, a controller for the light emitting diodes, and at least one remote controller. The light emitting diodes may be color changing. The light emitting diodes may emit a light which appears as an emoticon. The controller may be connected to a voice recorder which sends its output to a speaker located in the side rear view mirror or elsewhere on the motor vehicle.

A fifth embodiment of a vehicle side rear view mirror having means to display information to communicate with other individuals outside of the vehicle wherein the controller may be a voice activated controller.

A sixth embodiment of a vehicle side rear view mirror having means to display information to communicate with other individuals outside of the vehicle wherein the controller may be a gesture activated controller.

A seventh embodiment of a vehicle side rear view mirror having means to display information to communicate with other individuals outside of the vehicle wherein the light emitting diode matrix is detatchably fixed to the mirror case.

### Advantages

Accordingly several advantages of one or more aspects are as follows: to communicate emoticons to other drivers and pedestrians, and to communicate audibly with other drivers and pedestrians, which could be a voice. To communicate through a voice activated controller. To communicate through a gesture activated controller. Other advantages of one or more aspects will be apparent from a consideration of the drawings and ensuing description.

### BRIEF DESCRIPTION OF THE DRAWINGS

FIG. 1 is a side view of a motor vehicle with a first embodiment of the invention.

FIG. 2 is a top view, partially cutaway of a mirror assembly incorporating a first embodiment of the invention.

FIG. 3 is a top view, partially cutaway of a mirror assembly incorporating a second embodiment of the invention.

FIG. 4 is a top view, partially cutaway of the mirror assembly incorporating a third embodiment of the invention.

FIG. 5 is a top view, partially cutaway of the mirror assembly incorporating a fourth embodiment of the invention.

FIG. 6 is a fifth embodiment of the invention.

FIG. 7 is a sixth embodiment of the invention.

FIG. 8 is a seventh embodiment of the invention.

### DETAILED DESCRIPTION OF THE PREFERRED EMBODIMENT

Most, if not all, motor vehicles are equipped with two side rear view mirror assemblies, and it will be appreciated by those skilled in the art that the discussion below applies equally to the driver side and passenger side rear view mirror assembly 10.

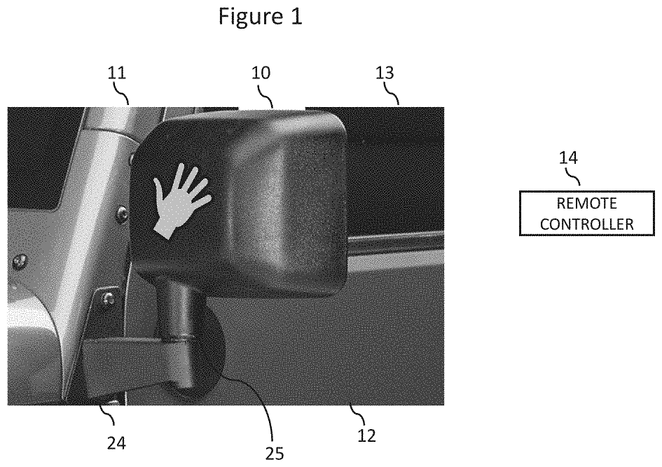

FIG. 1 shows the side rear view mirror assembly which is generally indicated at 10. The perspective of FIG. 1 is that of an observer outside of the vehicle. As the observer looks at the side rear view mirror assembly 10 and a portion of the motor vehicle 11. FIG. 1 includes a portion of a door 12, a window 13, and a controller 14, which is inside the vehicle 11.

The side rear view mirror assembly includes a base, 2F that is fixedly secured to the motor vehicle 11 and more specifically the door 12 of the vehicle 11. The base 24 is secured to the door 12. The design of the base 24 may include a support 25.

The base includes a mirror case 25 which is moveably secured to the base 24. The mirror case includes a lens 26 which is fixedly secured by known means to the mirror case 25. A waving hand shaped lens 26 in FIG. 1 may be shaped as additional emoticons or symbols. The mirror case 25 may include additional openings other than for the aperture 26 for turn signals, security lights, and the like. The mirror case 25 is aesthetically and aerodynamically similar to the general design of the vehicle.

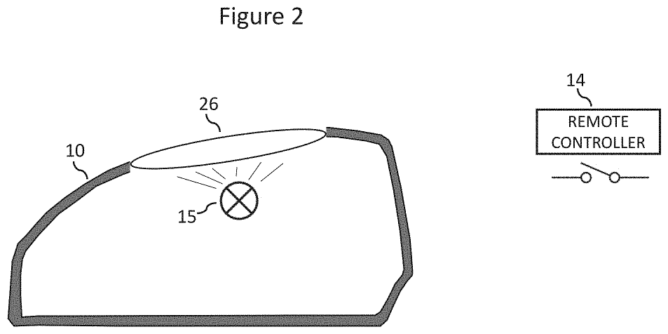

FIG. 2 is a top view, partially cutaway of the mirror assembly 10 incorporating a first embodiment of the invention. The side rear view mirror assembly 10 contains a lens 26 and a light source 15. The lens 26 allows light from the light source 15 to pass through. The light source 15 may be an amber lamp. The light source 15 is connected to a controller 14. Said light source could be used as a marker light. The controller 14 may be an electrical interrupter switch to cause the light source 15 to flicker, in which case the light source could be used as a turn signal or a hazard light.

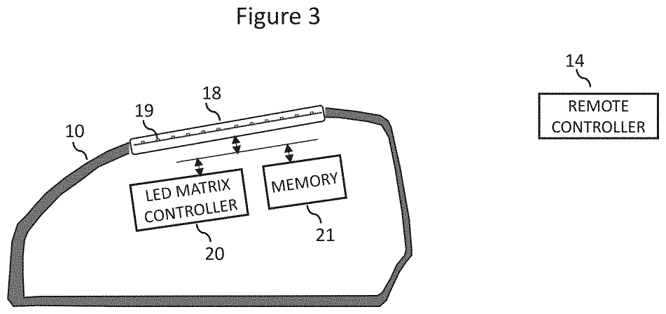

FIG. 3 is a top view, partially cutaway of the mirror assembly 10 incorporating a second embodiment of the invention. The side rear view mirror assembly 10 contains a transparent cover 18. The transparent cover 18 contains a light emitting diode matrix panel 19 which is fixedly secured in the transparent cover 18. The light emitting diode matrix panel 19 may be composed of color changing light emitting diodes. The light emitting diode matrix panel 19 is connected to a light emitting diode matrix panel controller 20. The matrix controller 20 may be connected to memory 21. The light emitting diode matrix panel controller 20 is connected to at least one controller represented by the controller 14. The light emitting diode matrix may be used as a turn signal, a hazard light, or a marker light.

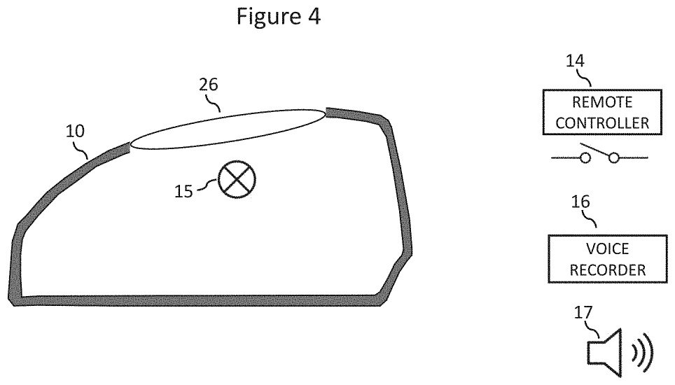

FIG. 4 is a top view, partially cutaway of the mirror assembly 10 incorporating a third embodiment of the invention. The side rear view mirror assembly 10 contains a lens 26 and a light source 15. The lens allows light from the light source 15 to pass through. The light source 15 may be an amber lamp. The light source 15 is connected to a controller 14. The controller 14 may be an electrical interrupter controller to cause the light source 15 to flicker. Said controller 14 is connected to a voice recorder 16 which may be placed elsewhere in the motor vehicle 11. The voice recorder 16 is connected to a speaker 17 which may be placed elsewhere in the motor vehicle 11.

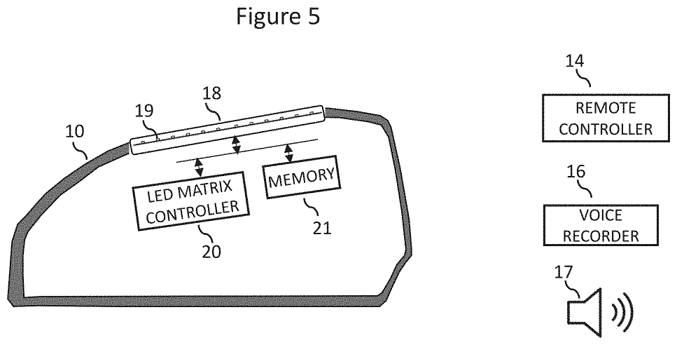

FIG. 5 is a top view, partially cutaway of the mirror assembly 10 incorporating a fourth embodiment of the invention. The side rear view mirror assembly 10 contains a transparent cover 18. The transparent cover 18 sits in front of a light emitting diode matrix panel 19 which is fixedly secured in the mirror assembly 10. The light emitting diode matrix panel 19 may be composed of color changing light emitting diodes. The light emitting diode matrix panel 19 is connected to a light emitting diode matrix panel controller 20. The light emitting diode matrix panel controller 20 is connected to at least one controller represented by the controller 14. Said controller 14 is connected to a voice recorder 16 which may be placed elsewhere in the motor vehicle 11. The voice recorder 16 is connected to a speaker 17 which may be placed elsewhere in the motor vehicle 11.

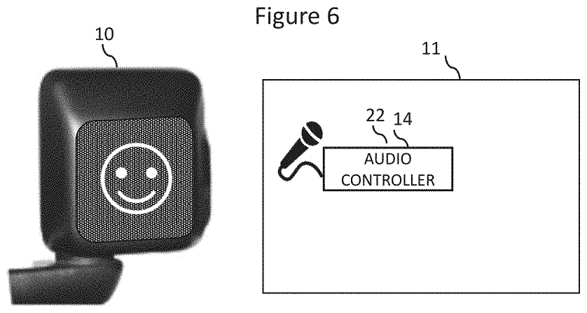

FIG. 6 is a fifth embodiment of the invention wherein the controller 14 is an audio controller 22 located inside the motor vehicle 11. The side rear view mirror assembly 10 could contain the light emitting diode array as explained in detail in FIG. 3, or the light source as detailed in FIG. 2.

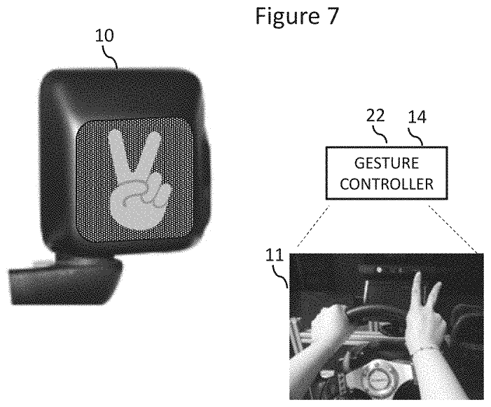

FIG. 7 is a sixth embodiment of the invention wherein the controller 14 is a gesture controller 23 located inside the motor vehicle 11. The side rear view mirror assembly 10 could contain the light emitting diode array as explained in detail in FIG. 3, or the light source as detailed in FIG. 2.

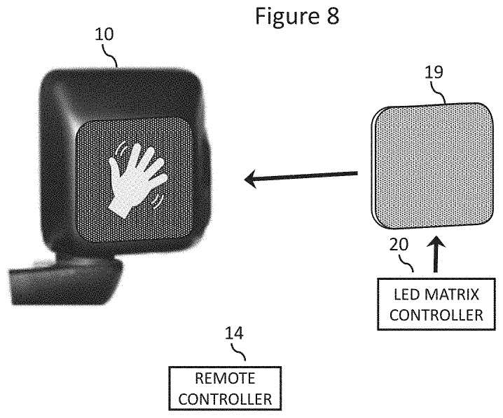

FIG. 8 is a seventh embodiment of the invention wherein the light emitting diode matrix panel 19 is detatchably fixed to the mirror case 10. The light emitting diode matrix panel is connected to a controller 20. The controller 20 is remotely connected to the remote controller 14.

Although there has been shown and described the preferred embodiments of the present invention, it will be readily apparent to those skilled in the art that modifications may be made thereto which do not exceed the scope of the appended claims. Therefore, the scope of the invention is only to be limited by the following claims.

I claim:

1. A side rear view mirror assembly for a motor vehicle having a means to display information to communicate with other individuals outside of the motor vehicle, the assembly comprising:
one or more light sources that when powered display a beam of light in a forward direction;
a shaped lens element covering said light source; and
a remote controller to control the light source.

2. The side view mirror assembly of claim 1 wherein the shaped lens element has an opening shaped as an emoticon.

3. The side rear view mirror assembly of claim 2 wherein the means to display information includes a means to project an audible sound.

4. The side rear view mirror assembly of claim 2 wherein the controller is an electrical interrupter switch.

5. The side rear view mirror assembly of claim 4 wherein the shaped lens functions as a turn signal.

6. The side rear view mirror assembly of claim 4 wherein the shaped lens functions as a hazard lamp.

7. The side rear view mirror assembly of claim 2 wherein the controller is voice controlled.

8. The side rear view mirror assembly of claim 2 wherein the controller is gesture controlled.

9. The side rear view mirror assembly of claim 2 wherein the shaped lens is part of the mirror case.

10. The side rear view mirror assembly of claim 2 wherein the shaped lens functions as a marker lamp.

11. A side rear view mirror assembly for a motor vehicle having a means to display information to communicate with other individuals outside of the motor vehicle, the assembly comprising:
a matrix of light emitting diodes that when powered display a beam of light in a forward direction;
a controller for the matrix of light emitting diodes; and
at least one remote controller to control the matrix of light emitting diodes.

12. The side rear view mirror assembly of claim 11 wherein the matrix of light emitting diodes displays an emoticon.

13. The side rear view mirror assembly of claim 12 wherein the light emitting diode matrix is composed of an array of color changing light emitting diodes.

14. The side rear view mirror assembly of claim 12 wherein the means to display information includes a means to project an audible sound.

15. The side rear view mirror assembly of claim 12 wherein the controller has memory and means to display stored images sequentially.

16. The side rear view mirror assembly of claim 12 wherein the controller is voice controlled.

14. The side rear view mirror assembly of claim 12 wherein the controller is gesture controlled.

15. The side rear view mirror assembly of claim 12 wherein the matrix of light emitting diodes functions as a turn signal.

16. The side rear view mirror assembly of claim 12 wherein the matrix of light emitting diodes functions as a hazard lamp.

17. The side rear view mirror assembly of claim 11 wherein the matrix of light emitting diodes functions as a marker lamp.
